(19) United States
(12) Patent Application Publication
(10) Pub. No.: US 2021/0308636 A1
(43) Pub. Date: Oct. 7, 2021

(54) TETRAHYDROCANNABINOL EMULSION AND METHOD OF MAKING AND USING

(71) Applicant: Brian Brown, Lafayette, IN (US)

(72) Inventor: Andrew Brown, Alamosa, CO (US)

(21) Appl. No.: 17/220,361

(22) Filed: Apr. 1, 2021

Related U.S. Application Data
(60) Provisional application No. 63/003,940, filed on Apr. 2, 2020.

(51) Int. Cl. B01F 3/08; A23L 2/52; A23L 33/105; A23L 33/115; B01D 11/02; A23L 29/00; A23L 29/10

(52) U.S. Cl. CPC B01F 3/0811; A23L 2/52; A23L 33/105; B01F 2003/0842; B01D 11/0288; A23L 29/035; A23L 29/10; A23L 33/115

(57) ABSTRACT

A hemp extract-based emulsion and method for forming includes cannabinoids, including at least tetrahydrocannabinol and cannabigerol, at least one emulsifier, and an aqueous phase. An emulsion of at least the tetrahydrocannabinol is present as droplets suspended in the aqueous phase.

### CROSS-REFERENCE TO RELATED APPLICATION

This application claims priority to U.S. Provisional Patent Application No. 63/003,940, filed on Apr. 2, 2020, entitled “TETRAHYDROCANNABINOL EMULSION AND METHOD OF MAKING AND USING,” the contents of which are incorporated herein by reference in their entirety.

### FIELD OF THE DISCLOSURE

The present disclosure generally relates to an emulsion of tetrahydrocannabinol (THC) and methods of making and using, and more specifically to an emulsion of THC that can be consumed by a user as a food, beverage product, and/or topical application.

### BACKGROUND OF THE DISCLOSURE

Cannabinoids are a family of chemical compounds that are naturally occurring in the Cannabis sativa plant, such as hemp plants and marijuana plants. More than 70 different types of cannabinoids have been identified, many of which are believed to have psychoactive and/or therapeutic effects on the human body. The effect of cannabinoids on the human body can vary based on a number of different factors, examples of which include the type of cannabinoid(s) and the manner in which the cannabinoid(s) is consumed, whether it be ingestion, inhalation, or topical application to a user's body.

Tetrahydrocannabinol (THC) is an example of a cannabinoid that is known to have psychoactive effects when consumed in sufficient amounts and can interact with cannabinoid-1 (CB-1) receptors in the brain to produce a euphoric or “high” sensation. In contrast, cannabidiol (CBD) is considered a non-psychoactive cannabinoid that has been reported by some users to have therapeutic effects when consumed. For example, some users have reported a reduction in anxiety and/or pain following CBD consumption. It is believed that additional cannabinoids may also have therapeutic effects. Both hemp and marijuana plants contain cannabinoids. One difference between hemp plants and marijuana plants is that hemp plants typically contain no more than about 0.3% THC (by dry weight of the plant), whereas marijuana plants can contain 5% or more, sometimes up to 20%, of THC (by dry weight of the plant).

Several methods exist for extracting the desired cannabinoid(s) from hemp plants. For example, one method for extracting CBD from hemp plants includes the use of a solvent-based extraction process to extract cannabinoids from the hemp plant and then additional processing, such as filtering, fractionation, chromatography, precipitation, etc., are typically implemented in order to isolate the CBD and optionally other desired cannabinoids.

### SUMMARY OF THE DISCLOSURE

According to an aspect of the present disclosure, a method of forming a product including tetrahydrocannabinol is provided. The method can include condensing cannabinoids from a hemp extract to form a distillate including at least cannabidiols, tetrahydrocannabinol, and cannabigerol. The distillate can be combined with an organic solvent to form a first mixture. At least a portion of the cannabidiols are separated from the first mixture on a filter and a portion of the first mixture that passes through the filter is collected as a filtrate, wherein the filtrate includes tetrahydrocannabinol and cannabigerol. The method also includes forming an emulsion including the filtrate and an aqueous solvent, wherein the emulsion includes droplets of at least tetrahydrocannabinol suspended in the aqueous solvent.

According to another aspect of the present disclosure, a hemp extract-based emulsion includes cannabinoids including at least tetrahydrocannabinol and cannabigerol, at least one emulsifier, and an aqueous phase. At least the tetrahydrocannabinol is present as droplets suspended in the aqueous phase.

According to yet another aspect of the present disclosure, a beverage includes an oil-in-water emulsion containing cannabinoids including at least tetrahydrocannabinol and cannabigerol suspended in an aqueous phase and at least one emulsifier. The tetrahydrocannabinol includes Δ⁹-tetrahydrocannabinol, and wherein a concentration of Δ⁹-tetrahydrocannabinol in the beverage is about 0.3% or less (by weight of the beverage).

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a flow chart illustrating a method of forming an emulsion including droplets having THC suspended in an aqueous phase, according to aspects of the present disclosure.

### DETAILED DESCRIPTION

The present disclosed embodiments reside primarily in a product comprising an emulsion of THC, including at least Δ⁹-tetrahydrocannabinol (Δ⁹-THC), suitable for consumption by a user, and methods of making and using said THC emulsion. Specifically, the THC emulsion is formed from a filtrate material that remains following a solvent-based extraction process to isolate CBD from hemp extract. As used herein, the terms “tetrahydrocannabinol” and “THC” are used interchangeably and refer to at least Δ⁹-tetrahydrocannabinol (Δ⁹-THC), and may optionally include additional forms of THC, such as Δ⁸-tetrahydrocannabinol (Δ⁸-THC), for example. Accordingly, the method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Aspects of the present disclosure relate to an emulsion including THC, including at least Δ⁹-THC, which can be consumed by a user, through ingestion as a food and/or beverage product and/or by topical application. The source of THC in the emulsion is from a filtrate that remains after a solvent-based extraction of CBD from hemp. CBD can have significant commercial value, due at least in part to its reputation as being a therapeutic for a wide variety of ailments in humans and animals (e.g., pets). Thus, many extraction processes that are configured to extract CBD from hemp result in the additional material extracted from the hemp being disposed of as a waste product. Aspects of the present disclosure relate to capturing waste material that is collected during extraction of CBD from hemp and forming an emulsion using this material. The waste material, also referred to as mother liquor, can include a mixture of cannabinoids including at least tetrahydrocannabinol (THC) and cannabigerol (CBG). The emulsion formed using the mother liquor can be used to form a food or beverage that a user can ingest or a topical product that a user can apply to the body topically.

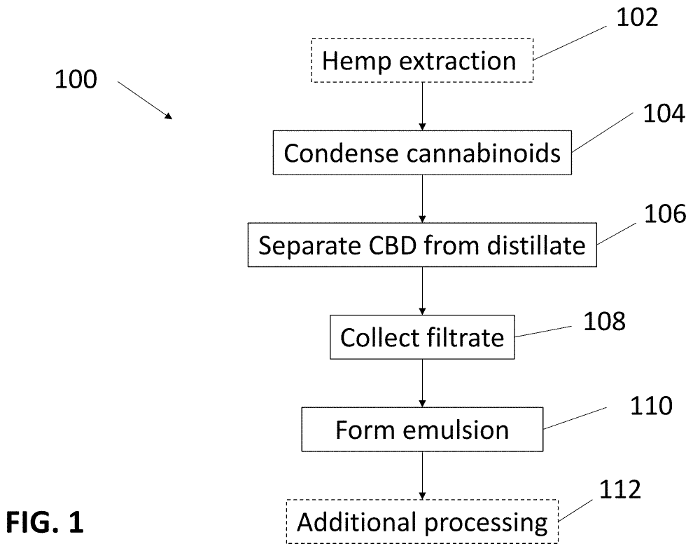

FIG. 1 illustrates an exemplary method 100 for forming a product including a THC emulsion. The method 100 can be used to form an emulsion including THC, including at least Δ⁹-THC, that can be directly consumed by a user or which may be utilized as a concentrate for further processing to form a product for consumption by a user, such as a food, beverage, or topical application product. It will be understood that the method 100 can include additional, alternative, and/or intermediate steps without deviating from the scope of the present disclosure. In some aspects, the steps of the method 100 may be implemented in an in-line process with each step being implemented upon completion of the previous step. In other aspects, one or more of the steps of the method 100 may be completed and the product produced by that step can be stored for future use in subsequent steps.

The method 100 can include an extraction step 102, which includes extracting cannabinoids from hemp. The hemp can be from any suitable source and may be processed as desired prior to extraction. For example, in some aspects, the hemp may optionally be dried and/or ground prior to extraction. In other examples, green hemp may be used (i.e., hemp that has not undergone a drying process). In some aspects, only portions of the hemp plant may be utilized in the extraction step 102. For example, in some aspects, the hemp flower may be separated from other parts of the plants and only the hemp flower may be processed in the extraction step 102. In other examples, hemp seed and/or chaff may be used in the extraction step 102. While the extraction step 102 is described in the context of a hemp extraction step, it will be understood that the extraction step 102 could utilize other Cannabis plants as an alternative or in addition to hemp. The method 100 may be utilized with any suitable species of plant from which cannabinoids can be extracted, non-limiting examples of which include Cannabis sativa, Cannabis indica, and Cannabis ruderalis.

The extraction step 102 includes extracting cannabinoids from the hemp using one or more solvents in a solvent extraction process. Non-limiting examples of suitable solvents for extracting cannabinoids in the extraction step 102 include pentane, hexane, toluene, trimethylpentane, ethanol, chlorinated hydrocarbons, chloroform, dichloromethane, and supercritical fluids (e.g., supercritical carbon dioxide). Parameters of the extraction step 102, such as solvent residency time, a ratio of hemp material to solvent, solvent volume, etc . . . , may be based at least in part on the solvent used and the type and/or amount of hemp material used (e.g., hemp plant part, dry vs. green, etc.). In some examples, the hemp material may have a residency time in the extraction solvent of less than about 4 hours, less than about 3 hours, less than about 2 hours, less than about 1, or less than about 30 minutes. For example, the hemp material may have a residency time in the extraction solvent of from about 5 minutes to about 4 hours or any time period within this range. In some examples, the residency time in the extraction solvent may be about 5 minutes or less, about 10 minutes or less, about 15 minutes or less, about 20 minutes or less, about 25 minutes or less, or about 30 minutes or less. The volume ratio of hemp material to solvent can be any suitable ratio such that the hemp material is at least partially suspended in the solvent. The parameters of the extraction step 102 can be selected based on any known extraction process utilizing organic solvents or supercritical fluids to extract cannabinoids from hemp material.

According to an aspect of the present disclosure, the extraction step 102 can occur as an in-line process with the subsequent condensation step 104. In other aspects, the cannabinoid extract produced by the extraction step 102 may be stored for later processing in the condensation step 104. In still other aspects of the present disclosure, the extraction step 102 may not form part of the method 100 and a suitable cannabinoid extract may be purchased from a supplier.

At step 104, referred to as the condensation step 104, the cannabinoid extract can be condensed and the distillate can be collected for further processing. In some aspects, the distillate produced by the condensation step 104 may have greater than about 85% by weight (wt %) of cannabinoids. For example, the distillate may have greater than about 85 wt %, greater than about 87 wt %, greater than about 90 wt %, greater than about 91 wt %, or greater than about 92 wt %. In some examples, the distillate produced from the condensation step 104 may have from about 85 wt % to about 95 wt %, about 85 wt % to about 93 wt %, about 85 wt % to about 92 wt %, about 85 wt % to about 91 wt %, about 90 wt % to about 95 wt %, about 90 wt % to about 93 wt %, or about 90 wt % to about 92 wt % of cannabinoids. In some aspects, a ratio of the cannabinoids present in the extract is generally maintained in the distillate collected in the condensation step 104.

The condensation step 104 may proceed according to conventional processes for condensation of a material from a solvent. For example, the condensation may include heating the cannabinoid extract, optionally under reduced pressure, to induce evaporation of the cannabinoids. The evaporated cannabinoids can be condensed using conventional condensing equipment, such as a cooling coil, and the condensed cannabinoids can be collected in a receiving receptacle.

The cannabinoid distillate produced in the condensation step 104 can then be combined with an organic solvent to separate cannabidiol (CBD) from the cannabinoid distillate at a separation step 106. The separation step 106 can include mixing the cannabinoid distillate with a suitable organic solvent for a predetermined period of time, under predetermined temperature conditions to form a solvent mixture. The mixing time and temperature and the amount of organic solvent used may vary based on the organic solvent used. In some examples, the separation step 106 may include multiple cycles of solvent addition and mixing. One example of a suitable organic solvent for separating CBD from the cannabinoid distillate includes pentane. In another example, the organic solvent can be any suitable hydrocarbon or alkane solvent, non-limiting examples of which include propane, butane, pentane, hexane, heptane, and mixtures thereof.

The mixture of organic solvent and cannabinoid distillate can then be filtered to separate CBD from the mixture and the remaining portion of the mixture can be collected as a filtrate for further processing. In one example, the mixture can be processed in a vacuum filter set-up that includes passing the mixture through a suitable filter media under vacuum (i.e., at reduced pressure compared to ambient) to facilitate passage of the mixture through the filter media. The filter media can have a pore size suitable for retaining CBD solids on the filter media while allowing other portions of the mixture to pass through. The material collected on the filter media can optionally be rinsed with an organic solvent one or more times. The solvent used to rinse the filter media and collected material may be the same or different than the solvent initially mixed with the cannabinoid distillate. In one example, the filter media may be filter paper having a pore size of about 5 μm. The material collected on the filter media, also referred to as the CBD isolate, is typically greater than about 97 wt % CBD, and in some cases may be greater than about 98 wt %, greater than about 99 wt %, or greater than about 99.5 wt % CB, although it will be understood that additional materials may be collected on the filter media.

The material that passes through the filter media, referred to as the filtrate, includes at least THC, specifically at least Δ⁹-THC, and cannabigerol (CBG), and may optionally include additional materials and/or cannabinoid species. In some examples, the filtrate may also include CBD that does not crystallize and thus is not captured by the filter media.

At step 108, the filtrate produced in the separation step 106 may be collected and further processed to remove at least a portion of the organic solvent from the filtrate. In one example, the collected filtrate may be heated and/or treated under vacuum (i.e., reduced pressure) to remove at least a portion of the organic solvent from the filtrate. For example, a conventional rotary evaporator can be used to evaporate the organic solvent, under heating and/or reduced pressure, and in this manner remove at least a portion of the organic solvent from the filtrate and preferably removes substantially all of the organic solvent. Typically, greater than about 98%, greater than about 99%, greater than about 99.9%, or substantially all of the organic solvent is evaporated from the filtrate. In one aspect, the filtrate material that remains behind following removal of the organic solvent includes at least Δ⁹-THC and CBG, and may optionally include CBD and/or other cannabinoid species.

According to one aspect of the present disclosure, at step 110, the filtrate material including at least Δ⁹-THC and CBG can be combined with a mixture of an aqueous solvent (e.g., water) and one or more emulsifiers to form an emulsion of at least Δ⁹-THC and CBG. The one or more emulsifiers can be added to the mixture to facilitate stabilizing the emulsion of at least Δ⁹-THC and CBG. Non-limiting examples of suitable emulsifiers include lecithin, starch-based emulsifiers, gum arabic, fatty acid esters, sodium stearoyl lactylate, monoglycerides, diglycerides, palm oil, and Xanthan gum. The type and/or amount of emulsifiers can be selected based at least in part on an intended use of the product and the desired characteristics of the emulsion (e.g., stability, droplet size, presence of additional materials, etc.). In one example, the emulsifier(s) are combined with the aqueous solvent and at least partially dissolved prior to combining the aqueous solvent/emulsifier(s) mixture with the filtrate material

According to another aspect of the present disclosure, step 110 can optionally include combining a plant-based oil with the filtrate material including at least Δ⁹-THC and CBG prior to combining with the aqueous solvent/emulsifier(s) mixture. The filtrate material (post-solvent evaporation) can be combined with a suitable plant-based oil that is safe for consumption, by ingestion and/or topical application, to form an oil mixture. The type and/or amount of plant-based oil combined with the filtrate material may be selected at least in part based on the intended use of the product, a desired effect on bioavailability of the THC, and/or a desired viscosity of the filtrate-oil mixture. Non-limiting examples of suitable plant-based oils include hemp seed oil, hemp oil, vegetable oil, olive oil, coconut oil, sesame oil, sunflower oil, and soybean oil. Other types of oils known in the industry to be safe for ingestion and/or topical application may also be used without deviating from the scope of the present disclosure.

The filtrate-oil mixture can be combined with the aqueous solvent (e.g., water) and optionally one or more emulsifiers to form an oil-in-water emulsion. Without wishing to be limited by any theory, it is believed that the plant-based oil can combine with the THC and CBG (and optionally other cannabinoids present in the filtrate) and act as a carrier oil to facilitate formation of an emulsion of droplets of THC and/or CBG suspended in an aqueous phase. The one or more emulsifiers can be added to the mixture to facilitate stabilizing the oil-in-water emulsion. Non-limiting examples of suitable emulsifiers include lecithin, starch-based emulsifiers, gum arabic, fatty acid esters, sodium stearoyl lactylate, monoglycerides, diglycerides, palm oil, and Xanthan gum. The type and/or amount of emulsifiers can be selected based at least in part on an intended use of the product and the desired characteristics of the emulsion (e.g., stability, droplet size, presence of additional materials, etc.).

According to one aspect of the present disclosure, the filtrate material or the filtrate-oil mixture including at least Δ⁹-THC and CBG can be combined with the aqueous solvent, and optional additives, to form an emulsion in which a concentration of Δ⁹-THC in the emulsion is selected at least in part based on an intended use of the emulsion. In some aspects, a concentration of Δ⁹-THC in the emulsion can be greater than 0 wt % and about 10 wt % or less, about 8 wt % or less, about 6 wt % or less, about 5 wt % or less, about 4 wt % or less, about 2 wt % or less, about 1 wt % or less, about 0.8 wt % or less, about 0.6 wt % or less, about 0.4 wt % or less, about 0.3 wt % or less, about 0.2 wt % or less, about 0.08 wt % or less, about 0.06 wt % or less, about 0.04 wt % or less, about 0.03 wt % or less, or about 0.02 wt % or less. In some aspects, the concentration of Δ⁹-THC in the emulsion is from greater than 0 wt % to about 0.3 wt %. In some examples, when the emulsion is intended to be consumed as a beverage, the concentration of Δ⁹-THC may be about 0.02 wt % or less. In some aspects, the concentration of Δ⁹-THC in the emulsion may be greater than about 10 wt %, based on the intended use of the emulsion. For example, the emulsion may be formed as a concentrate having a higher concentration of Δ⁹-THC than desired in an intermediate or end product and the emulsion may be combined with one or more components to dilute the concentration of Δ⁹-THC to a final desired concentration based on the intended use of the emulsion. In one aspect, high pressure liquid chromatography (HPLC) can be used to determine the concentration of Δ⁹-THC in the filtrate and the amount of oil (when present), aqueous solvent, and/or optional additives to be combined with the emulsion can be determined based on the HPLC results to provide an emulsion having the desired concentration of Δ⁹-THC.

In some aspects, the filtrate material and/or filtrate-oil mixture, aqueous solvent, and optional additives are treated in a homogenization process to provide an emulsion having the desired characteristics, such as droplet size and/or droplet size distribution. In one example, the homogenization process can include treatment with an ultrasonic homogenizer. Parameters of the homogenization process, such as time and amplitude of the acoustic waves, can be selected to provide an emulsion having the desired characteristics. Optionally, the homogenized mixture can be passed through a suitable filter media to sterilize the mixture. For example, the homogenized mixture can be passed through a filter media having a pore size of 0.2 μm.

According to one aspect of the present disclosure, the emulsion can be characterized by droplets of at least Δ⁹-THC suspended in the aqueous phase having an average diameter of less than about 1000 nm. As used herein, an emulsion having an average droplet diameter of less than about 1000 nm may be referred to as a nanoemulsion. In some aspects, the emulsion can be a nanoemulsion characterized by an average droplet diameter of less than about 1000 nm, less than about 800 nm, less than about 750 nm, less than about 500 nm, less than about 300 nm, less than about 250 nm, less than about 100 nm, or less than about 50 nm. In some examples, the emulsion may be characterized by droplets having a range of diameters of from about 40 nm to about 300 nm. In some examples, the emulsion may be characterized by droplets having a diameter of about 300 nm or less and a size distribution that is normally distributed (i.e., approximates a bell curve). In some examples, the emulsion may include droplets having diameters characterized by a normal distribution centered at from about 125 nm to about 175 nm. In some aspects, the emulsion may be characterized by a unimodal or a multimodal droplet size distribution.

In some aspects, when the filtrate material is combined with an oil to form the filtrate-oil mixture, the emulsion can be in the form of an oil-in-water emulsion that includes droplets of at least Δ⁹-THC and CBG suspended in the aqueous phase. The suspended droplets may include a mixture of Δ⁹-THC and CBG and/or droplets that are predominately formed from a single cannabinoid species, such as droplets that contain predominately Δ⁹-THC and/or droplets that contain predominately CBG. In some examples, the emulsion may include droplets including CBD and/or other cannabinoid species.

At step 112, the method 100 can optionally include additional processing of the emulsion formed at step 110. In some aspects, the additional processing at step 112 can include the addition of one or more additives to the emulsion. Non-limiting examples of suitable additives include antioxidants, flavoring agents, colorants, dyes, essential oils, aroma compounds, ascorbic acid, and limonene. In one exemplary embodiment, an antioxidant, such as ascorbic acid, can be added to the emulsion. Without wishing to be limited by any theory, it is believed that antioxidants, such as ascorbic acid, may decrease the rate of degradation of THC in the emulsion. In another exemplary embodiment, limonene can be added to the emulsion. Without wishing to be limited by any theory, it is believed that limonene may enhance the psychoactive effect of the emulsion and/or may provide a desirable flavor to the emulsion. According to some aspects, the emulsion may be combined with both ascorbic acid and limonene.

The emulsion formed at step 110 can be mixed with any suitable additives and processed according to the intended use of the emulsion. For example, when the emulsion is intended to be ingested, it may be desirable to combine the emulsion with additives that provide a pleasant flavor and/or appearance to a consumer. When the emulsion is intended by applied topically, the emulsion may be combined with additives that facilitate topical application or provide a pleasant aroma to a user.

According to some aspects of the present disclosure, the emulsion formed at step 110 can be used as formed and consumed directly as a beverage or “shot.” In some aspects, the emulsion formed at step 110 can be in the form of a concentrate that is diluted before consumption. For example, the emulsion can be provided as a concentrate that is mixed with a beverage or added to a food product for ingestion by a user. In another example, the emulsion can be provided as a concentrate that is then combined with materials that are intended to be applied topically by a user.

### EXAMPLES

The following examples describes various features and advantages provided by the disclosure, and is in no way intended to limit the present disclosure and appended claims.

### Example 1

An exemplary method for forming a THC emulsion according to the present disclosure can include using an unrefined, CBD-rich hemp extract (“crude extract”) that has been produced from a solvent extraction of hemp flower as a source of THC. The crude extract was heated to approximately 80° C. to lower the viscosity of the material. The crude extract was then pumped via a gear pump into a wiped-film molecular distillation unit. The distillation unit had a diameter of about 6 inches and the crude extract was pumped at a rate of about 15 mL to about 20 mL per minute. Teflon wipers were used to spread the material across the inside of the evaporation chamber (vertical cylinder). The surface of the evaporation chamber was maintained at a temperature of about 165° C. to about 180° C. The interior of the evaporation chamber was held under vacuum (about 0.01 Torr to about 0.05 Torr). The cannabinoids were condensed by a cooling coil within the condenser cylinder. The condenser was maintained at a temperature of about 60° C. to about 70° C. The condensed cannabinoids were collected in a receiving flask. The collected fraction, referred to as the distillate, was about 90 wt % to about 92 wt % of cannabinoids. The distillate had approximately the same ratio of cannabinoids as the hemp crude extract. About 93 wt % to about 96 wt % of the cannabinoids present in the crude extract were extracted into the distillate.

The distillate was then placed into a jacketed mixing vessel. For every 3 parts of distillate, 1 part of room-temperature pentane was added. The distillate and pentane mixture was then mixed to obtain a solution that appeared homogeneous (by visual inspection). The jacketed vessel was then cooled to a temperature of about −10° C. while the solution was mixed with an overhead mixer. During mixing, the solution began to thicken and clumps of material including CBD formed after several minutes.

After mixing for several minutes, an aliquot of cooled pentane (about −10° C.) was added, with continued stirring. The aliquot of pentane was equivalent to about 1/10th of the original volume of the distillate placed in the mixing vessel. The mixture initially became smooth and homogeneous in appearance. After several more minutes of stirring, the mixture again began to clump together. Upon the appearance of clumps, an additional aliquot of cooled pentane was added (same amount as the previous aliquot). The process of adding an aliquot of cooled pentane and mixing was repeated about 7-10 times until the solution thickened, but does not form visible clumps. The mixer was then turned off and the mixture was allowed to rest for approximately 15 minutes.

After resting, the mixture of distillate and pentane was poured into a Buchner funnel with filter paper having a 5 μm pore size. The funnel was connected with an Erlenmeyer flask that was connected to a vacuum pump. The mixture was added to the funnel, with the vacuum pump on (to reduce pressure within the flask) to facilitate drawing material through the filter paper and into the collection flask. Cold pentane (approximately half the volume of the original amount of distillate) was poured over the material collected on the filter paper. The material collected on the filter was a white crystalline powder that was over 99 wt % CBD (referred to as the CBD isolate). The material that passed through the filter was collected in the flask (referred to as the filtrate) and included at least Δ⁹-THC, CBG, and CBD.

The filtrate was then process in a rotary evaporator to remove the pentane. The pressure inside the rotary evaporate was drawn to 50 Torr and then the vacuum pump was turned off. The condenser was cooled to a temperature of about −20° C. and the water bath was heated to a temperature of about 50° C. The flask was rotated at about 160 rpm. Once visible boiling of the pentane subsided, the temperature of the water bath was increased to about 90° C. and the vacuum pump was turned back on and the vacuum was maintained for about 2 hours to evaporate residual pentane. The filtrate material remaining in the flask had an amber, syrupy appearance and included at least Δ⁹-THC and CBG, and may have included a small amount of CBD.

The filtrate material in the flask was then combined with hemp seed oil at a 1:1 ratio and mixed to form a filtrate-oil mixture. Without wishing to be limited by any theory, it is believed that mixing the material with hemp seed oil lowers the viscosity of the material, which can facilitate forming an emulsion of THC droplets, and may also improve the bioavailability of the THC when the emulsion is consumed. In order to make 1 liter of a THC emulsion solution in which the THC content was about 0.3 wt %, about 60 grams of this 1:1 solution was combined with a water/emulsifier mixture. The THC content was determined using HPLC and the THC content was used to determine the amount of the 1:1 solution to be used to form 1 liter of the emulsion with the desired THC content.

The water/emulsifier mixture was formed by combining about 840 grams of distilled water with about 50 grams of lecithin and about 50 grams of Ingredion Purity Gum® Ultra (a starch-based emulsifier). The mixture was allowed to soak for about 24 hours, with agitation every few hours until the starch and lecithin were thoroughly wet.

The 1:1 solution was combined with the water/emulsifier mixture and stirred to combine. This mixture was then pumped through a flow cell of a 400 Watt Hielscher Ultrasonic homogenizer at a flow rate of about 150 mL/min. to form an oil-in-water emulsion. The homogenizer was set at 100% amplitude. The material pumped through the flow cell was returned to the receptacle in which the 1:1 solution and the water/emulsifier mixture were being mixed. This process was repeated until the mixture appeared homogenous, which was typically about 10 min. to about 15 min. per liter of material. The oil-in-water emulsion was then passed through a 0.2 μm pore size filter to sterilize the emulsion.

The oil-in-water emulsion can be consumed directly in small amounts (e.g., 2 mL to 4 mL shots) or it can be combined with a food or beverage product for consumption. The oil-in-water emulsion may also be combined with ingredients suitable for topical application, such as an oil, ointment, or cream, for example. In other examples, the oil-in-water emulsion can be combined with ascorbic acid and limonene and then directly consumed by a user.

### Example 2

Another exemplary method for forming a THC emulsion containing at least Δ⁹-THC and CBG according to the present disclosure can include using an unrefined, CBD-rich hemp extract (“crude extract”) that has been produced from a solvent extraction of hemp flower as a source of THC. A filtrate material containing at least Δ⁹-THC and CBG was prepared in a manner similar to that described above in Example 1, except that Example 2 included combining the filtrate material with a mixture of water (aqueous solvent) and an emulsifier without the step of forming a filtrate-oil mixture.

A 1 liter emulsion batch was made by combining 920 grams of distilled water with 50 grams of a starch-based emulsifier (e.g., Ingredion Purity Gum® Ultra). The mixture was allowed to soak for about 24 hours, with agitation every few hours until the emulsifier was dissolved in the water and no visible undissolved pieces remained. The mixture had a slightly hazy visual appearance. Optionally, the rate of dissolving the emulsifier in the water can be increased by mixing at a high shear rate.

Once the emulsifier was dissolved in the water such that no visible undissolved pieces remain, the water/emulsifier mixture was mixed with 30 grams of the filtrate material containing at least Δ⁹-THC and CBG using a laboratory stirring apparatus operating at about 1500 rpm. However, faster stirring rates would also work. For example, a high shear mixer operating at around 20,000 rpm can also be used. The mixture was then pumped through a flow cell of a 400 Watt Hielscher Ultrasonic homogenizer at a flow rate of about 150 mL/min. to form an emulsion. The homogenizer was set at 100% amplitude (which is estimated to provide about 90 Watts into the solution). The output flow from the flow cell was cycled back through the homogenizer multiple times until the mixture reached the desired homogeneity to form an emulsion containing at least Δ⁹-THC and CBG. Typically, cycling times of about 10-15 minutes per liter are sufficient to reach the desired homogeneity.

Alternatively, the mixture containing the water/emulsifier mixture and the filtrate material can be made without the flow cell in batches. In this configuration, the size of each batch is determined by the size of the equipment. For example, 1-10 L size batches could be processed through a 400 Watt Hielscher Ultrasonic homogenizer, operating at a 100% amplitude (inputs about 90 Watts into the solution), at a rate of about 5-10 minutes per liter. The bottom of the horn can of the ultrasonic homogenizer can be placed about 1 cm below the surface of the mixture. If the mixture can be mixed in a high shear mixer that can disperse the filtrate material in the water/emulsifier mixture to the point at which no drops of the filtrate material are visible to the naked eye, it may be possible to process the mixture using the homogenizer without continuously stirring the mixture.

### Example 3

Example 3 was made in the same manner as described above for Example 2 except that Example 3 utilized a different emulsifier. For Example 3, 880 grams of distilled water was combined with 90 grams of Gum Arabic (emulsifier) and mixed until the Gum Arabic was dissolved such that there were no visible pieces of undissolved material in the mixture. The water/emulsifier mixture was then combined with 30 grams of filtrate material and processed as described above in Example 2 using a homogenizer to form an emulsion containing at least Δ⁹-THC and CBG.

The following non-limiting aspects are encompassed by the present disclosure. To the extent not already described, any one of the features of the following aspects may be combined in part or in whole with features of any one or more of the other aspects of the present disclosure to form additional aspects, even if such a combination is not explicitly described.

According to a first aspect of the present disclosure, a method of forming a product including tetrahydrocannabinol includes: condensing cannabinoids from a hemp extract to form a distillate comprising at least cannabidiols, tetrahydrocannabinol, and cannabigerol; combining the distillate with an organic solvent to form a first mixture; separating at least a portion of the cannabidiols from the first mixture on a filter and collecting a portion of the first mixture that passes through the filter as a filtrate, wherein the filtrate comprises tetrahydrocannabinol and cannabigerol; and forming an emulsion comprising the filtrate and an aqueous solvent, wherein the emulsion comprises droplets of at least tetrahydrocannabinol suspended in the aqueous solvent.

In a second aspect, according to the method of aspect 1, further comprising combining the filtrate with a plant-based oil to form a second mixture, and wherein the step of forming an emulsion comprises combining the second mixture and the aqueous solvent.

In a third aspect, according to the method of aspect 2, wherein the plant-based oil is at least one material selected from hemp oil, hemp seed oil, vegetable oil, olive oil, coconut oil, sesame oil, sunflower oil, and soybean oil.

In a fourth aspect, according to the method of any one of aspects 1-3, the forming an emulsion includes combining at least one emulsifier with the second mixture.

In a fifth aspect, according to the method of aspect 4, the at least one emulsifier is at least one material selected from lecithin, starch-based emulsifiers, gum arabic, fatty acid esters, sodium stearoyl lactylate, monoglycerides, diglycerides, palm oil, and Xanthan gum.

In a sixth aspect, according to the method of any one of aspects 1-5, tetrahydrocannabinol comprising at least Δ⁹-tetrahydrocannabinol in an amount of greater than 0 wt % and about 10% or less (by weight of the emulsion).

In a seventh aspect, according to the method of any one of aspects 1-6, tetrahydrocannabinol comprising at least Δ⁹-tetrahydrocannabinol in an amount of greater than 0 wt % and about 0.3% or less (by weight of the emulsion).

In an eighth aspect, according to the method of any one of aspects 1-7, the method further includes combining the emulsion with at least one additional component selected from antioxidants, flavoring agents, colorants, dyes, essential oils, aroma compounds, ascorbic acid, and limonene.

In a ninth aspect, according to the method of any one of aspects 1-8, an average diameter of the droplets of at least tetrahydrocannabinol is about 300 nm or less.

In a tenth aspect, according to the method of any one of aspects 1-9, wherein subsequent to the forming an emulsion, the method further includes: homogenizing the emulsion and passing the homogenized emulsion through a filter.

According to a eleventh aspect of the present disclosure, a hemp extract-based emulsion includes cannabinoids including at least tetrahydrocannabinol and cannabigerol; at least one emulsifier; and an aqueous phase, wherein at least the tetrahydrocannabinol is present as droplets suspended in the aqueous phase.

In a twelfth aspect, the hemp extract-based emulsion of aspect 11, further comprising a plant-based oil, and wherein the plant-based oil and at least the tetrahydrocannabinol are present as droplets suspended in the aqueous phase.

In a thirteenth aspect, the hemp extract-based emulsion of aspect 12, wherein the plant-based oil is at least one material selected from hemp oil, hemp seed oil, vegetable oil, olive oil, coconut oil, sesame oil, sunflower oil, and soybean oil.

In a fourteenth aspect, the hemp extract-based emulsion of any one of aspects 11-13, wherein an average diameter of the droplets is about 300 nm or less.

In a fifteenth aspect, the hemp extract-based emulsion of any one of aspects 11-14, wherein the tetrahydrocannabinol comprises Δ⁹-tetrahydrocannabinol, and wherein a concentration of Δ⁹-tetrahydrocannabinol is from greater than 0 wt % to about 10% or less (by weight of the emulsion).

In a sixteenth aspect, the hemp extract-based emulsion of any one of aspects 11-15, wherein the tetrahydrocannabinol comprises Δ⁹-tetrahydrocannabinol, and wherein a concentration of Δ⁹-tetrahydrocannabinol is from greater than 0 wt % to about 0.3 wt % or less (by weight of the emulsion).

In a seventeenth aspect, the hemp extract-based emulsion of any one of aspects 11-16, wherein the at least one emulsifier is at least one material selected from lecithin, starch-based emulsifiers, gum arabic, fatty acid esters, sodium stearoyl lactylate, monoglycerides, diglycerides, palm oil, and Xanthan gum.

In an eighteenth aspect, the hemp extract-based emulsion of any one of aspects 11-17, further including at least one additional component selected from antioxidants, flavoring agents, colorants, dyes, essential oils, and aromatic compounds.

In a nineteenth aspect, the hemp extract-based emulsion of any one of aspects 11-18, further including at least one of ascorbic acid and limonene.

According to a twentieth aspect of the present disclosure, a beverage includes an emulsion comprising cannabinoids including at least tetrahydrocannabinol and cannabigerol suspended in an aqueous phase; and at least one emulsifier, and wherein the tetrahydrocannabinol comprises Δ⁹-tetrahydrocannabinol, and wherein a concentration of Δ⁹-tetrahydrocannabinol is from greater than 0 wt % to about 0.3% or less (by weight of the beverage).

In a twenty-first aspect, the beverage of aspect 20, wherein the emulsion comprises an oil-in-water emulsion comprising a plant-based oil and cannabinoids including at least tetrahydrocannabinol suspended in an aqueous phase.

In a twenty-second aspect, the beverage of aspect 21, wherein the plant-based oil is at least one material selected from hemp oil, hemp seed oil, vegetable oil, olive oil, coconut oil, sesame oil, sunflower oil, and soybean oil.

In a twenty-third aspect, the beverage of any one of aspects 20-22, further including at least one of ascorbic acid and limonene.

In a twenty-fourth aspect, the beverage of any one of aspects 20-23, wherein a source of the cannabinoids is a filtrate collected from filtering a solvent extraction of hemp.

In a twenty-fifth aspect, the beverage of any one of aspects 20-24, wherein the emulsion is a nanoemulsion including droplets having an average diameter of less than about 300 nm.

In a twenty-sixth aspect, the beverage of any one of aspects 20-25, wherein a concentration of Δ⁹-tetrahydrocannabinol is from greater than 0 wt % to about 0.02% or less (by weight of the beverage).

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law. It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

It will be understood by one having ordinary skill in the art that construction of the described concepts, and other components, is not limited to any specific material. Other exemplary embodiments of the concepts disclosed herein may be formed from a wide variety of materials, unless described otherwise herein.

The construction and arrangement of the elements of the present disclosure, as shown in the exemplary embodiments, is illustrative only. Although only a few embodiments of the present disclosure have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements and/or assemblies of the present disclosure may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

It will be understood that any described processes, or steps within described processes, may be combined with other disclosed processes or steps to form embodiments within the scope of the present disclosure. The exemplary embodiments and processes disclosed herein are for illustrative purposes and are not to be construed as limiting.

What is claimed is:

1. A method of forming a product comprising tetrahydrocannabinol, the method comprising:
condensing cannabinoids from a hemp extract to form a distillate comprising at least cannabidiols, tetrahydrocannabinol, and cannabigerol;
combining the distillate with an organic solvent to form a first mixture;
separating at least a portion of the cannabidiols from the first mixture on a filter and collecting a portion of the first mixture that passes through the filter as a filtrate, wherein the filtrate comprises tetrahydrocannabinol and cannabigerol; and
forming an emulsion comprising the filtrate and an aqueous solvent, wherein the emulsion comprises droplets of at least tetrahydrocannabinol suspended in the aqueous solvent.

2. The method of claim 1, further comprising:
combining the filtrate with a plant-based oil to form a second mixture, and
wherein the step of forming an emulsion comprises combining the second mixture and the aqueous solvent.

3. The method of claim 2, wherein the plant-based oil is at least one material selected from hemp oil, hemp seed oil, vegetable oil, olive oil, coconut oil, sesame oil, sunflower oil, and soybean oil.

4. The method of claim 1, wherein the forming an emulsion comprises combining at least one emulsifier with the aqueous solvent.

5. The method of claim 4, wherein the at least one emulsifier is at least one material selected from lecithin, starch-based emulsifiers, gum arabic, fatty acid esters, sodium stearoyl lactylate, monoglycerides, diglycerides, palm oil, and Xanthan gum.

6. The method of claim 1, wherein the emulsion comprises tetrahydrocannabinol comprising at least Δ⁹-tetrahydrocannabinol in an amount of from greater than 0 wt % to about 10% or less (by weight of the emulsion).

7. The method of claim 1, wherein an average diameter of the droplets of at least tetrahydrocannabinol is about 300 nm or less.

8. A hemp extract-based emulsion, comprising:
cannabinoids comprising at least tetrahydrocannabinol and cannabigerol;
at least one emulsifier; and
an aqueous phase,
wherein at least the tetrahydrocannabinol is present as droplets suspended in the aqueous phase.

9. The hemp extract-based emulsion of claim 8, further comprising:
a plant-based oil, and
wherein the plant-based oil and at least the tetrahydrocannabinol are present as droplets suspended in the aqueous phase.

10. The hemp extract-based emulsion of claim 9, wherein the plant-based oil is at least one material selected from hemp oil, hemp seed oil, vegetable oil, olive oil, coconut oil, sesame oil, sunflower oil, and soybean oil.

11. The hemp extract-based emulsion of claim 8, wherein an average diameter of the droplets is about 300 nm or less.

12. The hemp extract-based emulsion of claim 8, wherein the tetrahydrocannabinol comprises Δ⁹-tetrahydrocannabinol, and wherein a concentration of Δ⁹-tetrahydrocannabinol is from greater than 0 wt % to about 10% or less (by weight of the emulsion).

13. The hemp extract-based emulsion of claim 8, wherein the at least one emulsifier is at least one material selected from lecithin, starch-based emulsifiers, gum arabic, fatty acid esters, sodium stearoyl lactylate, monoglycerides, diglycerides, palm oil, and Xanthan gum.

14. The hemp extract-based emulsion of claim 8, further comprising at least one of ascorbic acid and limonene.

15. A beverage, comprising:
an emulsion comprising cannabinoids including at least tetrahydrocannabinol and cannabigerol suspended in an aqueous phase; and
at least one emulsifier, and
wherein the tetrahydrocannabinol comprises Δ⁹-tetrahydrocannabinol, and wherein a concentration of Δ⁹-tetrahydrocannabinol is from greater than 0 wt % to about 0.3% or less (by weight of the beverage).

16. The beverage of claim 15, wherein the emulsion comprises an oil-in-water emulsion comprising a plant-based oil and cannabinoids including at least tetrahydrocannabinol suspended in an aqueous phase.

17. The beverage of claim 16, wherein the plant-based oil is at least one material selected from hemp oil, hemp seed oil, vegetable oil, olive oil, coconut oil, sesame oil, sunflower oil, and soybean oil.

18. The beverage of claim 15, further comprising at least one of ascorbic acid and limonene.

19. The beverage of claim 15, wherein a source of the cannabinoids is a filtrate collected from filtering a solvent extraction of hemp.

20. The beverage of claim 15, wherein the emulsion is a nanoemulsion comprising droplets having an average diameter of less than about 300 nm.
